(19) United States
(12) Patent Application Publication
(10) Pub. No.: US 2015/0035184 A1
(43) Pub. Date: Feb. 5, 2015

(54) SUBSTRATE MANUFACTURING FACILITY AND METHOD OF MANUFACTURING SUBSTRATE

(71) Applicant: Samsung Electronics Co., Ltd., Suwon-si (KR)

(72) Inventors: Gwangsick KIM, Asan-si (KR); JaeYong PARK, Cheonan-si (KR)

(21) Appl. No.: 14/447,590

(22) Filed: Jul. 30, 2014

(30) Foreign Application Priority Data
Aug. 1, 2013 (KR) 10-2013-0091678

(51) Int. Cl. B29C 33/10

(52) U.S. Cl. CPC B29C 33/10
USPC 264/39; 425/73; 425/135

(57) ABSTRACT

A substrate manufacturing facility includes a lower molding plate and an upper molding plate. A resin supply tray provides resin powder to a top surface of the lower molding plate. The lower and upper molding plates may compress a substrate and the resin powder. The upper molding plate has multiple apertures. The apertures are densely formed on a front side of the upper molding plate. The front side of the upper molding plate contacts the substrate. The apertures have diameters smaller than diameters of the resin powder. The substrate manufacturing facility includes a vacuum pump, a ventilator, a conduit, a controller, and valves. The substrate manufacturing facility can adsorb a circuit board using adsorption pressure from the vacuum pump and clean residue from the upper molding using exhaustion pressure from the ventilator.

### CROSS-REFERENCE TO RELATED APPLICATION

This U.S. non-provisional patent application claims priority under 35 U.S.C. §119 to Korean Patent Application No. 10-2013-0091678, filed on Aug. 1, 2013, in the Korean Intellectual Property Office, the disclosure of which is hereby incorporated by reference in its entirety.

### BACKGROUND

The inventive concepts relate to a substrate manufacturing facility and a method of manufacturing a substrate and, more particularly, to a substrate manufacturing facility for molding a substrate and a method of manufacturing a substrate.

A semiconductor device may be sealed by a mold package. The package may protect a semiconductor device from external physical environments or damage. Semiconductor molding facilities may include an extrusion molder and a compression molder. The extrusion molder may be an extruding machine. The extrusion molder may provide a melted epoxy molding compound onto a top surface and a bottom surface of a semiconductor device to mold the semiconductor device.

The compression molder provides an epoxy molding compound onto a top surface of a semiconductor device mounted on a printed circuit board. More recently, extrusion molders are being replaced with compression molders in semiconductor production lines.

### SUMMARY

Embodiments of the inventive concepts may provide a substrate manufacturing facility capable of improving a production yield and a method of manufacturing a substrate using the same.

Embodiments of the inventive concepts may also provide a substrate manufacturing facility capable of improving productivity and a method of manufacturing a substrate using the same.

In one aspect, a substrate manufacturing facility may include: a lower molding plate including a plurality of grooves, a resin supply tray configured to provide resin powder for molding a substrate to the lower molding plate, and an upper molding plate configured to move the substrate over the lower molding plate, and to compress the substrate to the resin powder. The upper molding plate includes multiple apertures that may be densely formed on a side of the upper molding plate that contacts the substrate. The apertures may have diameters that are smaller than diameters of the resin powder.

In some embodiments, the resin powder may include minute particles having diameters of about 5 micrometers (μm) or more, and the diameters of the apertures may be about 3 μm or less.

In some embodiments, the upper molding plate may include: a first upper plate configured to contact the substrate, and a second upper plate fixed to the first upper plate. The first upper plate may include porous ceramic including the apertures. In some embodiments, the second upper plate may include nonporous ceramic.

In some embodiments, the first upper plate and the second upper plate may provide an air path connected to the apertures.

In some embodiments, the substrate manufacturing facility may further include a vacuum pump configured to provide adsorption pressure to the apertures through a conduit connected to the upper molding plate, and a ventilator configured to provide exhaust pressure to the apertures through the conduit.

In some embodiments, the substrate manufacturing facility may further include a film supply module configured to provide a film between the lower molding plate and the upper molding plate. The film supply module may be configured to provide the film to a top surface of the lower molding plate when the exhaust pressure is provided to the apertures by the ventilator.

In some embodiments, the substrate manufacturing facility may further include a first valve connected to or disposed within the conduit between the vacuum pump and the upper molding plate to switch the adsorption pressure, a second valve connected to or disposed within the conduit between the ventilator and the upper molding plate to switch the exhaust pressure, and a controller configured to control the switching of the adsorption pressure of the first valve and the switching of the exhaust pressure of the second valve.

In some embodiments, the controller is configured to close the first valve and to open the second valve when the upper molding plate is cleaned.

In some embodiments, the first valve may be closed and the second valve may be opened when the upper molding plate is cleaned.

In some embodiments, the controller is configured to close the first and second valves when the film is provided to the top surface of the lower molding plate in order to clean the upper molding plate

In some embodiments, the first and second valves may be closed when the film is provided to the top surface of the upper molding plate in order to clean the upper molding plate.

In some embodiments, the controller is configured to open the first valve and to close the second valve when the substrate is compressed and molded.

In some embodiments, the first valve may be opened and the second valve may be closed when the substrate is compressed and molded.

In another aspect, a method of manufacturing a substrate may include providing adsorption pressure to apertures of an upper molding plate to adsorb a substrate to the upper molding plate, providing resin powder into grooves of a lower molding plate,
melting the resin powder in the grooves, compressing the substrate with the melted resin powder, and cleaning the upper molding plate by exhaust pressure.

In some embodiments, cleaning the upper molding plate may include providing a film to a top surface of the lower molding plate, and providing the exhaust pressure to the apertures of the upper molding plate.

In some embodiments, the method may further include: removing the film after cleaning the upper molding plate.

In some embodiments, the resin powder may include minute particles having diameters of about 5 μm or more, and the apertures may have diameters of about 3 μm or less.

In yet another aspect of the inventive concepts, an apparatus may include a conduit, a vacuum pump coupled to the conduit, a ventilator coupled to the conduit, an upper molding plate including a first upper plate having apertures therein and a second upper plate connected to the conduit, wherein the second upper plate is connected to the first upper plate, and wherein the vacuum pump is configured to adsorb a printed circuit board to the first upper plate through adsorption pressure applied through the apertures, a lower molding plate including grooves therein, and a resin supply tray configured to provide resin powder into the grooves of the lower molding plate. In some embodiments, the lower molding plate may be configured to melt the resin powder. In some embodiments, the upper molding plate may be configured to compression-mold the printed circuit board with the melted resin powder using the lower molding plate. In some embodiments, the ventilator may be configured to clean residue particles of the resin powder from the upper molding plate by exhaust pressure applied through the apertures.

### BRIEF DESCRIPTION OF THE DRAWINGS

The inventive concepts will become more apparent in view of the attached drawings and accompanying detailed description.

FIG. 1 is a plan view illustrating a substrate according to example embodiments of the inventive concepts;

FIG. 2 is a side view illustrating a substrate of FIG. 1;

FIG. 3 is a plan view illustrating a substrate manufacturing facility according to example embodiments of the inventive concepts;

FIG. 4 is a cross-sectional view illustrating a resin supply module of FIG. 3;

FIG. 5 is a cross-sectional view illustrating a molding module of FIG. 3; and

FIGS. 6 to 12 are cross-sectional views illustrating a method of molding a printed circuit board and a unit substrate and a method of cleaning an upper molding plate.

### DETAILED DESCRIPTION OF THE EMBODIMENTS

The inventive concepts will now be described more fully hereinafter with reference to the accompanying drawings, in which exemplary embodiments of the inventive concepts are shown. The advantages and features of the inventive concepts and methods of achieving them will be apparent from the following exemplary embodiments that will be described in more detail with reference to the accompanying drawings. It should be noted, however, that the inventive concepts are not limited to the following exemplary embodiments, and may be implemented in various forms. Accordingly, the exemplary embodiments are provided only to disclose the inventive concepts and let those skilled in the art know the category of the inventive concepts. In the drawings, embodiments of the inventive concepts are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

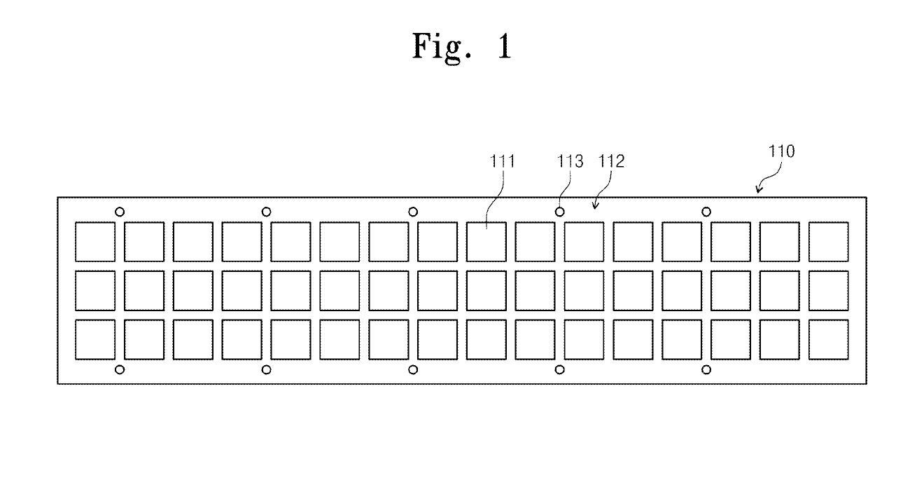

FIG. 1 is a plan view illustrating a substrate according to example embodiments of the inventive concepts. A substrate 110 may be a printed circuit board. The printed circuit board 110 may have a substantially rectangular shape. A plurality of unit substrates 111 are provided on the printed circuit board 110. Each of the unit substrates 111 may have a substantially rectangular shape. In some embodiments, each of the unit substrates 111 may be a semiconductor chip. At least one of semiconductor devices (e.g., an integrated circuit device, a volatile memory device, and a central processing unit (CPU)) may be integrated on each of the unit substrates 111. The unit substrates 111 are provided on a center region of the printed circuit board 110. In some embodiments, the number of the unit substrates 111 may be in the range of 51 to 135. In some embodiments, the unit substrates 111 may be arranged in 3 rows and 16 columns or in 5 rows and 27 columns FIG. 1 illustrates the unit substrates 111 arranged in 3 rows and 16 columns. In some embodiments, the unit substrates 111 of the same kind may be provided on one printed circuit board 110. The printed circuit board 110 may have edge regions 112. A plurality of first through-holes 113 may be disposed in the edge regions 112. The plurality of first through-holes 113 may be used to align or clamp the printed circuit board 110.

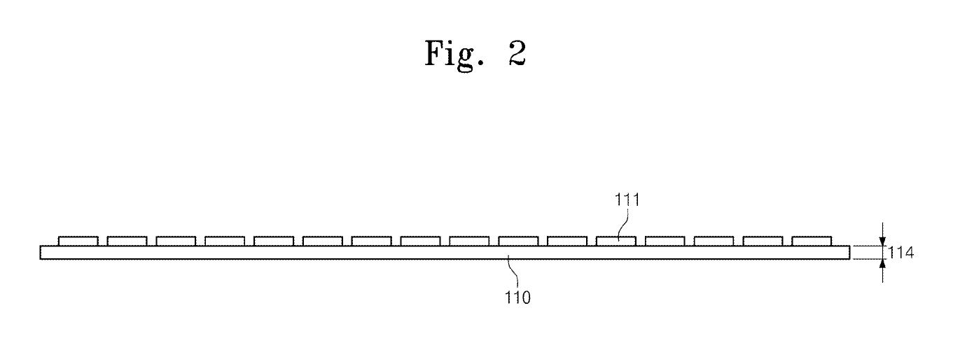

FIG. 2 is a side view illustrating the printed circuit board 110 of FIG. 1. The printed circuit board 110 may have a predetermined thickness 114. The thickness 114 of the printed circuit board 110 may be proportional to sizes of the unit substrates 111. In some embodiments, the thickness 114 of the printed circuit board 110 may be about 0.13 mm, about 0.1 mm, or about 0.08 mm. In some embodiments, the thickness 114 of the printed circuit board 110 may be 0.13 mm, 0.1 mm, or 0.08 mm. However, the inventive concepts are not limited thereto. The thickness 114 of the printed circuit board 110 may be variously modified.

In the following embodiments, a substrate manufacturing facility may perform a process on the printed circuit board 110. However, the inventive concepts are not limited thereto. The substrate manufacturing facility may perform a corresponding process on another kind of a printed circuit board. Alternatively or in addition, the substrate manufacturing facility may perform a corresponding process on different kinds of printed circuit boards at the same time.

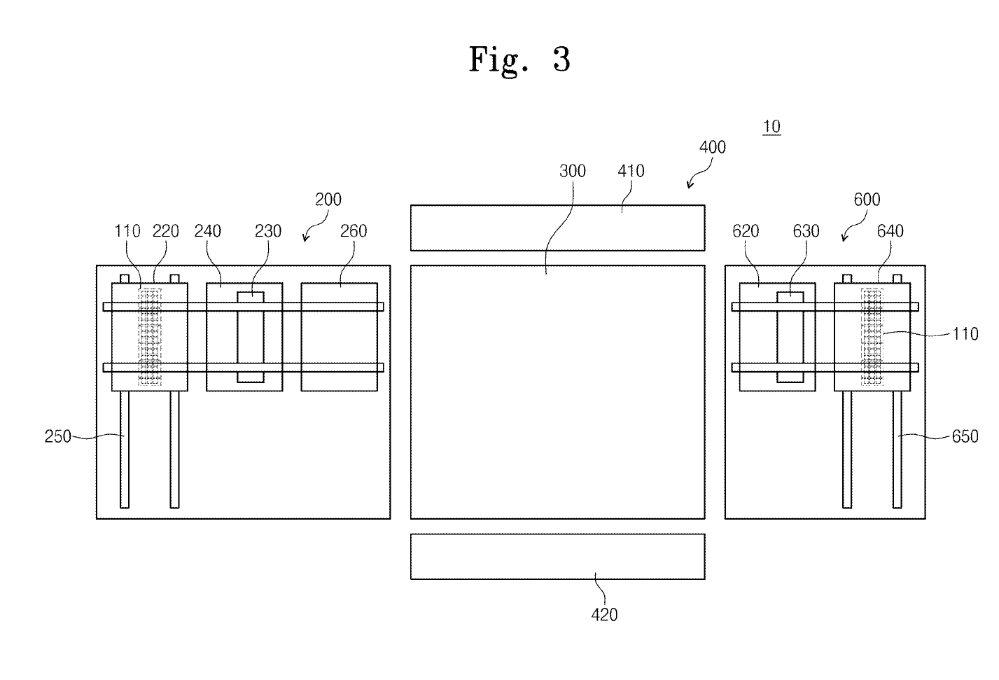

FIG. 3 is a plan view illustrating a substrate manufacturing facility 10 according to example embodiments of the inventive concepts.

Referring to FIGS. 1 and 3, the substrate manufacturing facility 10 may include a first apparatus 200, a molding apparatus 400, and/or a second apparatus 600. The first apparatus 200, the molding apparatus 400, and the second apparatus 600 may be arranged in series or in a circulation ring type arrangement. The first apparatus 200, the molding apparatus 400, and the second apparatus 600 are connected in-line to each other, and the printed circuit board 110 may be supplied into the first apparatus 200, the molding apparatus 400, and the second apparatus 600 in such order.

The first apparatus 200 performs a first process on the printed circuit board 110. The molding apparatus 400 performs a compression-molding process on the unit substrates 111 of the printed circuit board 110. The second apparatus 600 performs a second process on the printed circuit board 110. The first process, the compression-molding process, and the second process may be sequentially performed on the printed circuit board 110. The first process may include a preheating process of the printed circuit board 110 and a chip recognizing process. The second process may include a process of cooling and unloading the printed circuit board 110.

According to some embodiments, the first apparatus 200 may include a loader 220, a heating module 240, and a camera module 260. The camera module 260 is disposed to be adjacent to the molding apparatus 400. The loader 200 takes the printed circuit board 110 out of a magazine (not shown). The printed circuit board 110 may be transferred along a first conveyer member 250 of the loader 220. The heating module 240 preheats the printed circuit board 110. The camera module 260 obtains one or more images of the printed circuit board 110 and the unit substrate 111. The images of the unit substrate 110 may provide information about the number, positions, and sizes of the unit substrates 111 of the printed circuit board 110.

A first robot arm 230 may be provided to the loader 220, the heating module 240 and the camera module 260. The first robot arm 230 and/or the first conveyer member 250 sequentially transfer the printed circuit board 110 within the first apparatus 200. Additionally, after the recognizing process of the unit substrate 111 is completed, the first robot arm 230 and/or the first conveyer member 250 transfer the printed circuit board 110 having the recognized unit substrates 111 into the molding apparatus 400.

The second apparatus 600 may include a cooling module 620 and an unloader module 640. The cooling module 620 may be disposed to be adjacent to the molding apparatus 400. The cooling module 620 cools the printed circuit board 110 transferred from the molding apparatus 400. The unloader module 640 transfers the printed circuit board 110 into the magazine. The printed circuit board 110 may be moved along a second conveyer member 650 of the unloader module 640. A second robot arm 630 is provided inside or outside the cooling module 620 and the unloader module 640. The second robot arm 630 and/or the second conveyer member 650 may receive the printed circuit board 110 from the molding apparatus 400 and then may transfer the printed circuit board 110 to the cooling module 620 and the unloader module 640.

The molding apparatus 400 may include a molding module 300, a resin supply module 410, and a film supply module 420. The resin supply module 410 and the film supply module 420 may be disposed at both sides of a space between the first apparatus 200 and the second apparatus 600. The resin supply module 410 may provide epoxy molding compound (EMC) powder into the molding module 300. The film supply module 420 may provide a thin film into the molding module 300.

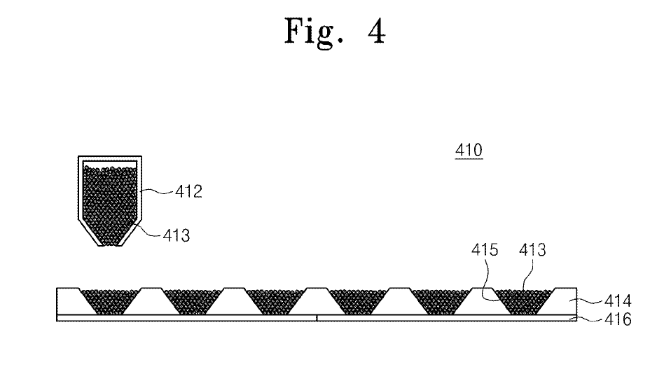

FIG. 4 is a cross-sectional view illustrating a resin supply module of FIG. 3. Referring to FIGS. 3 and 4, the resin supply module 410 may include a resin supply hopper 412, a resin supply tray 414, and shutters 416. The resin supply hopper 412 provides resin powder 413 to the resin supply tray 414 according to the information provided from the camera module 260. The resin powder 413 may include an epoxy molding compound (EMC). The resin powder 413 may include minute particles having diameters of about 5 μm or more. The resin supply tray 414 may have a plurality of second through-holes 415. The resin supply hopper 412 dispenses the resin powder 413 into the second through-holes 415. The shutters 416 may be installed on a bottom of the resin supply tray 414. The shutters 416 may open or close the second through-holes 415. When the shutters 416 are opened, the resin powder 413 in the second through-holes 415 may fall.

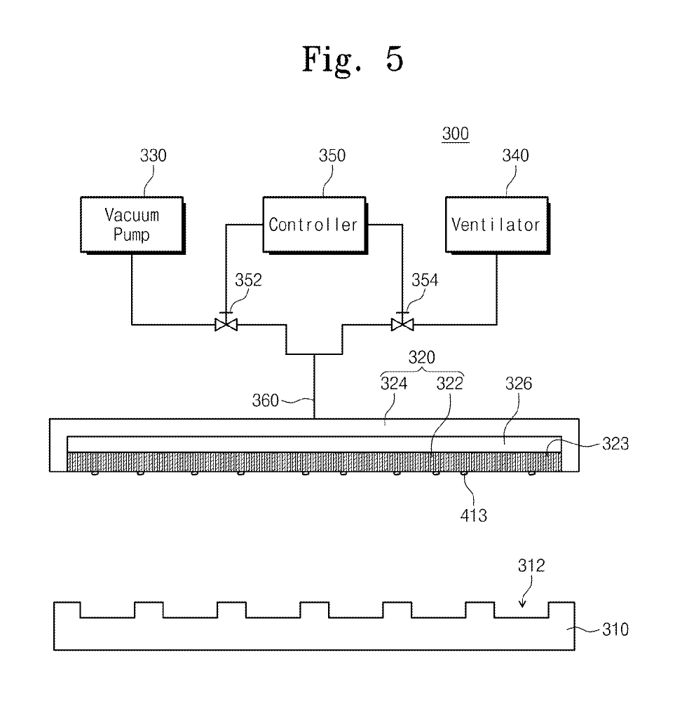

FIG. 5 is a cross-sectional view illustrating the molding module 300 of FIG. 3.

Referring to FIGS. 3 and 5, the molding module 300 may include a lower molding plate 310, an upper molding plate 320, a vacuum pump 330, a ventilator 340, and a controller 350. The lower molding plate 310 may have grooves 312. The grooves 312 are places in which the resin powder 413 falls. Additionally, the grooves 312 are places in which the unit substrates 111 can be molded.

The upper molding plate 320 may adsorb, or otherwise make contact with, the printed circuit board 110 using a vacuum. The upper molding plate 320 may include a first upper plate 322 and a second upper plate 324. The first upper plate 322 may include porous ceramic. The porous ceramic may include apertures 323 having diameters of 3 μm, or about 3 μm or less. In some embodiments, the apertures 323 may be densely formed in the porous ceramic with intervals of about 3 μm to about 10 μm therebetween. In some embodiments, the apertures 323 may be densely formed in the porous ceramic with intervals of 3 μm to 10 μm therebetween. When the molding process of the printed circuit board 110 and the unit substrate 111 is performed, the resin powder 413 may be adsorbed on, or otherwise make contact with, the first upper plate 322 formed of the porous ceramic.

As the thickness 114 of the printed circuit board 110 becomes thinner, the diameters of the apertures 323 of the upper molding plate 320 may become reduced. If the diameters of the apertures 323 are greater than the thickness 114 of the printed circuit board 110, the printed circuit board 110 may be partially damaged or bent. Additionally, the apertures 323 may be blocked by the resin powder 413. The resin powder 413 may not pass through the apertures 323 and may remain on a surface of the first upper plate 322. The second upper plate 324 surrounds an edge of the first upper plate 322. The first upper plate 322 may be fixed to the second upper plate 324. The second upper plate 324 may include nonporous ceramic. An air path 326 is provided between the first upper plate 322 and the second upper plate 324. The air path 326 may be connected to the apertures 323. Air of the vacuum pump 330 and/or the ventilator 340 may be moved through the apertures 323. The upper molding plate 320 may transfer the printed circuit board 110 from the heating module 240 (of FIG. 3) and from the camera module 260 of the first apparatus 200 (of FIG. 3) to the cooling module 620 of the second apparatus 600 (of FIG. 3).

The vacuum pump 330 and/or the ventilator 340 may be connected to the second upper plate 324 through a pipe or other suitable conduit 360. A first valve 352 may be connected to or otherwise disposed within the conduit 360 between the vacuum pump 330 and the upper molding plate 320. A second valve 354 may be connected to or otherwise disposed within the conduit 360 between the ventilator 340 and the upper molding plate 320. The vacuum pump 330 may provide adsorption pressure to the first upper plate 322. The vacuum pump 330 may include a dry pump. The ventilator 340 may provide exhaust pressure or ventilation pressure to the first upper plate 322. The controller 350 may control ON/OFF operation of each of the first valves 352 and 354.

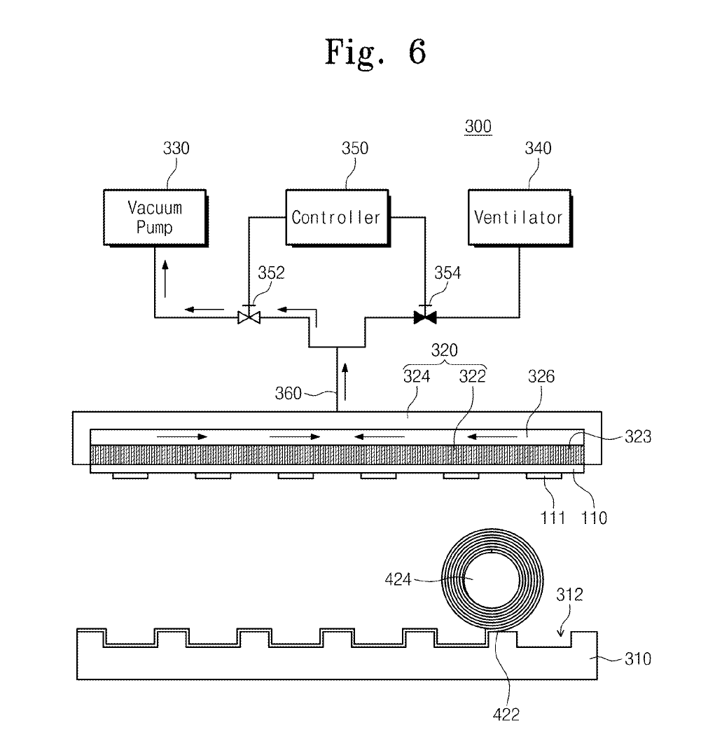

FIGS. 6 to 12 are cross-sectional views illustrating an apparatus and method of molding the printed circuit board 110 and the unit substrate 111, and a method of cleaning the upper molding plate 320.

Referring to FIGS. 3 and 6, the film supply module 420 supplies a top surface of the lower molding plate 310 with a film 422. The film 422 may be supplied by a roller 424 of the film supply module 420. The printed circuit board 110 may be fixed on the upper molding plate 320. The controller 350 may open the first valve 352 and may close the second valve 354. The upper molding plate 320 may hold the printed circuit board 110 by the adsorption pressure of the vacuum pump 330.

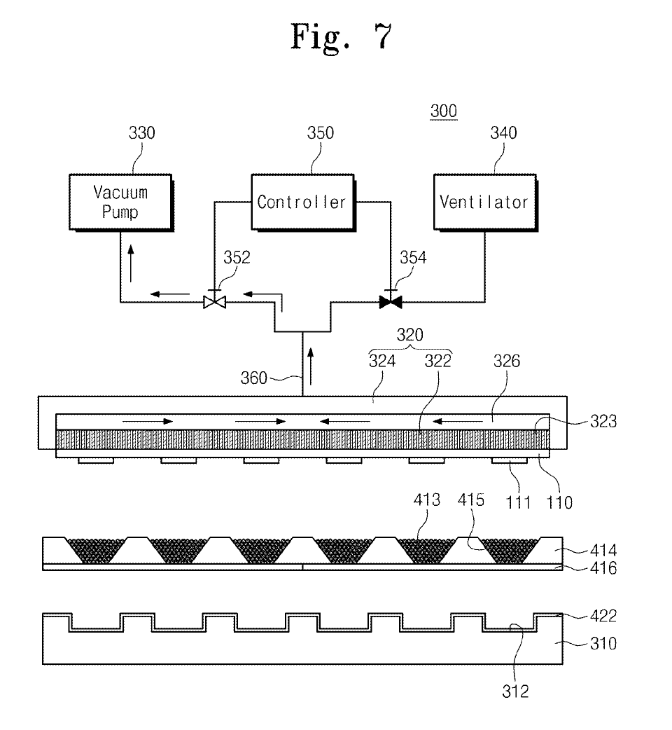

Referring to FIG. 7, the resin supply tray 414 is moved to be disposed between the lower molding plate 310 and the upper molding plate 320. The second through-holes 415 of the resin supply tray 414 are filled with the resin powder 413. The through-holes 415 of the resin supply tray 415 may be aligned over the grooves 312 of the lower molding plate 310, respectively. The printed circuit board 110 may be adsorbed on, or otherwise make contact with, the upper molding plate 320.

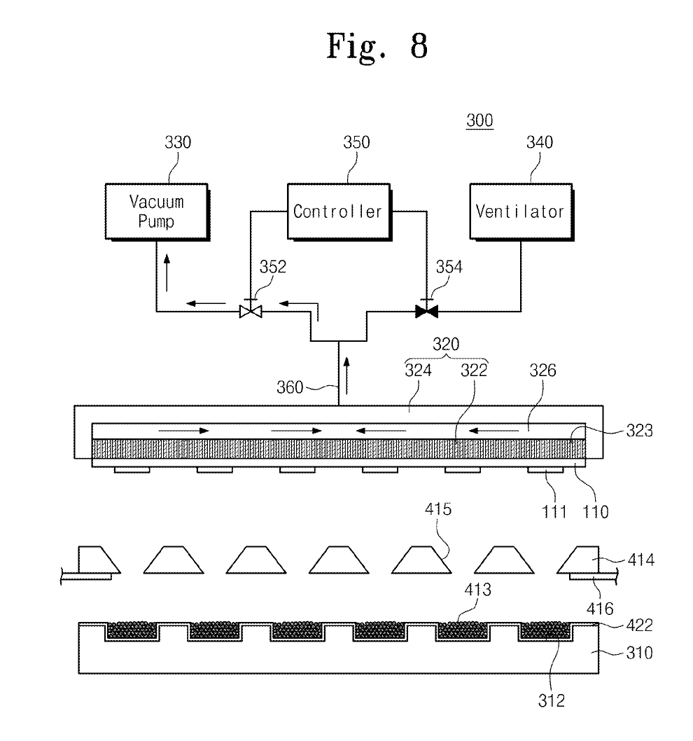

Referring to FIG. 8, the resin powder 413 is injected into the grooves 312 of the lower molding plate 310. Specifically, when the shutters 416 are opened, the resin powder 413 in the second through-holes 415 may fall into the grooves 312. In this case, the upper molding plate 320 still adsorbs the printed circuit board 110. If some of the resin powder 413 does not fall into the grooves 312, but rather floats or soars in an upward direction, then the apertures 323 of the upper molding plate 320 may be blocked by the soaring resin powder 413. The lower molding plate 310 may heat and melt the resin powder 413 in the grooves 312.

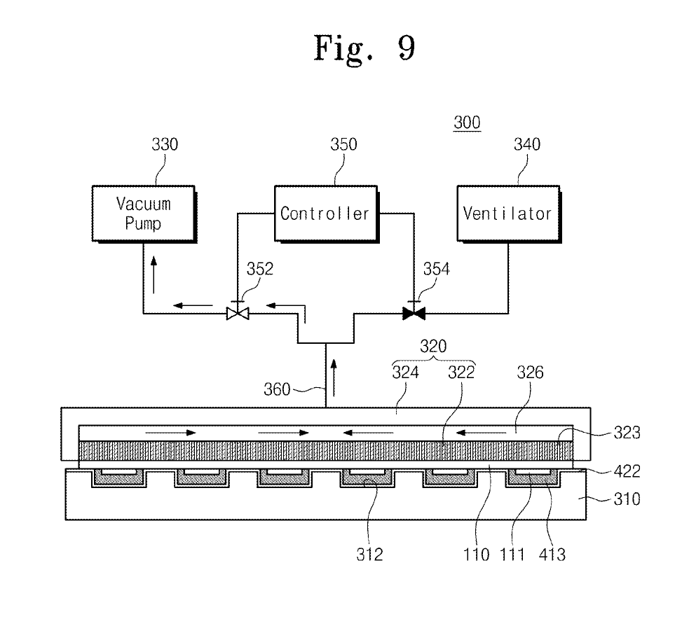

Referring to FIG. 9, the lower molding plate 310 and the upper molding plate 320 may compression-mold the printed circuit board 110 and the unit substrates 111. The printed circuit board 110 and the unit substrates 111 may be pressed on the film 422 and the resin powder 413 with high pressure. The lower molding plate 310 and the upper molding plate 320 may be moved toward each other to be adjacent to each other.

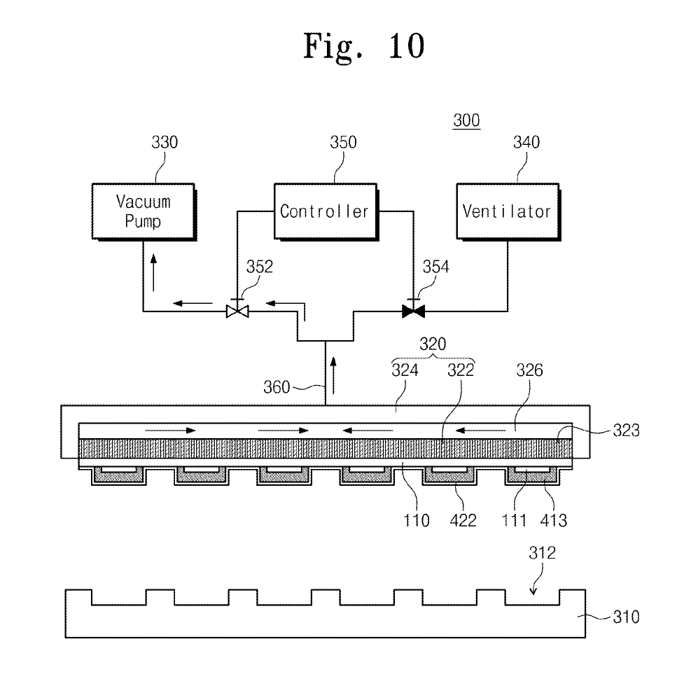

Referring to FIG. 10, the printed circuit board 110 is separated from the lower molding plate 310 and the upper molding plate 320. The lower molding plate 310 and the upper molding plate 320 may be relatively far away from each other. The printed circuit board 110 may be adsorbed on the upper molding plate 320. Thereafter, the adsorption pressure provided to the upper molding plate 320 may be removed to separate the printed circuit board 110 from the upper molding plate 320.

During the molding process, a large quantity of the resin powder 413 may be adsorbed on the apertures 323 of the upper molding plate 320. The printed circuit board 110 may sag on the upper molding plate 320 due to the resin powder 413 being adsorbed by the apertures 323. If the printed circuit board 110 sags, molding errors of the unit substrates 111 and the printed circuit board 110 may be caused. Thus, residue resin powder 413 may be removed by cleaning the apertures 323, thereby preventing sag.

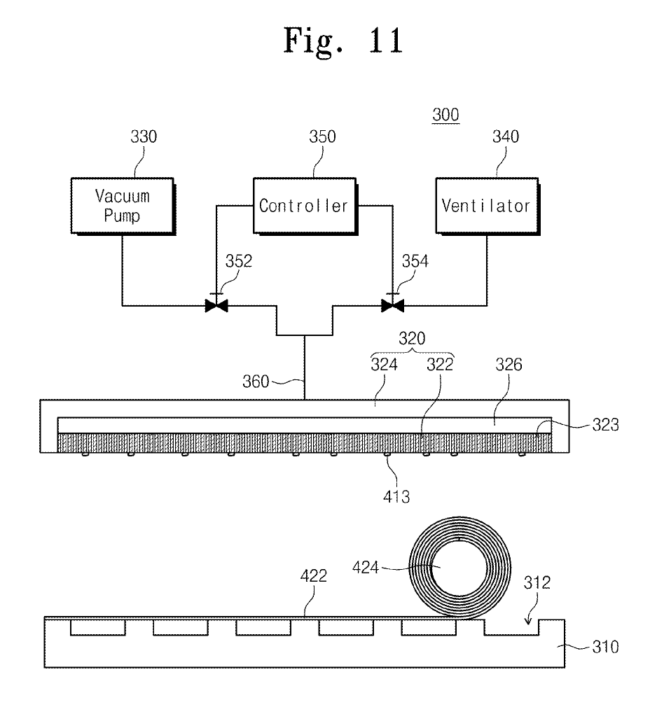

Referring to FIG. 11, a film 422 may cover the lower molding plate 310. The film 422 may cover an entire top surface of the lower molding plate 310. Each of the first and second valves 352 and 354 may be closed. The process of covering the lower molding plate 310 with the film 422 is a preliminary process of the cleaning process of the apertures 323, which is further described below.

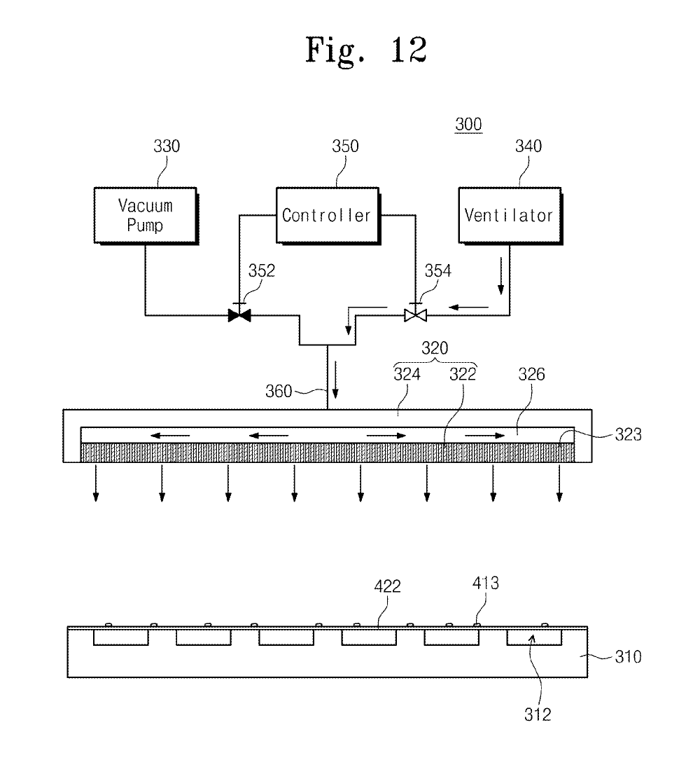

Referring to FIG. 12, the upper molding plate 320 can be cleaned. The controller 350 may close the first valve 352 and may open the second valve 354. The upper molding plate 320 may be cleaned by the ventilation of the ventilator 340. Residue particles (or grains) of the resin powder 413 may be separated from a bottom surface of the first upper plate 322. The residue particles (or the grains) of the resin powder 413 may fall on the film 422. The film 422 protects the lower molding plate 310 from the residue particles of the resin powder 413. The film formation process on the lower molding plate 310 and the cleaning process of the upper molding plate 320 may be performed simultaneously to constitute a single integrated process.

After the cleaning process of the upper molding plate 320 is completed, the controller 350 may close each of the first and second valves 352 and 354. The film 422 may be removed along with the resin powder 413 from the lower molding plate 310. Thereafter, the upper molding plate 320 may perform the process of molding the printed circuit board 110 and the unit substrates 111. In some embodiments, the cleaning process of the upper molding plate 320 may be periodically performed every unit of time. In some embodiments, the cleaning process of the upper molding plate 320 may be periodically performed every predetermined number of the molding process of the printed circuit board 110. In some embodiments, the cleaning process may be performed once at an interval of two days or five days. The cleaning process increases a lifetime of the upper molding plate 320. Thus, the substrate manufacturing facility 10 and the substrate manufacturing method according to embodiments of the inventive concepts may improve production yield and productivity.

In the aforementioned embodiments, the substrate is described as the printed circuit board. However, the inventive concepts are not limited thereto. In other embodiments, the substrate may be the unit substrate. The unit substrate is described as the semiconductor chip in the aforementioned embodiments. However, the inventive concepts are not limited thereto. The unit substrate may be a printed circuit board, a light emitting device, a light receiving device, a switching device, a resistor, or a capacitor.

The substrate manufacturing facility according to embodiments of the inventive concepts may include the upper molding plate having the apertures of the diameters smaller than those of the resin powder. The resin powder may not be inputted into the apertures and may be adsorbed on the surface of the upper molding plate. The resin powder may be removed by the ventilation cleaning process. Thus, the substrate manufacturing facility prevents lifetime reduction of the upper molding plate caused by blocking of the resin powder. If a large quantity of resin powder occurs on the upper molding plate, sagging fail of the printed circuit board may be caused. The resin powder may be removed from the apertures by the ventilation cleaning process as disclosed herein. The apertures may prevent molding fail caused by the sagging fail of the printed circuit board.

As a result, the substrate manufacturing facility and the substrate manufacturing method according to the inventive concepts improve the production yield and the productivity.

While the inventive concepts have been described with reference to example embodiments, it will be apparent to those skilled in the art that various changes and modifications may be made without departing from the spirits and scopes of the inventive concepts. Therefore, it should be understood that the above embodiments are not limiting, but illustrative. Thus, the scopes of the inventive concepts are to be determined by the broadest permissible interpretation of the following claims and their equivalents, and shall not be restricted or limited by the foregoing description.

What is claimed is:

1. A substrate manufacturing facility comprising:
a lower molding plate including a plurality of grooves;
a resin supply tray configured to provide resin powder for molding a substrate to the lower molding plate; and
an upper molding plate configured to move the substrate over the lower molding plate, and to compress the substrate to the resin powder, wherein the upper molding plate includes multiple apertures that are densely formed on a side of the upper molding plate that contacts the substrate, and wherein the apertures have diameters that are smaller than diameters of the resin powder.

2. The substrate manufacturing facility of claim 1, wherein:
the resin powder includes minute particles having diameters of about 5 μm or more, and
the diameters of the apertures are about 3 μm or less.

3. The substrate manufacturing facility of claim 1, wherein the upper molding plate comprises:
a first upper plate configured to contact the substrate; and
a second upper plate fixed to the first upper plate,
wherein the first upper plate includes porous ceramic including the apertures.

4. The substrate manufacturing facility of claim 3, wherein the second upper plate includes nonporous ceramic.

5. The substrate manufacturing facility of claim 3, wherein the first upper plate and the second upper plate provide an air path connected to the apertures.

6. The substrate manufacturing facility of claim 1, further comprising:
a vacuum pump configured to provide adsorption pressure to the apertures through a conduit connected to the upper molding plate; and
a ventilator configured to provide exhaust pressure to the apertures through the conduit.

7. The substrate manufacturing facility of claim 6, further comprising:
a film supply module configured to provide a film between the lower molding plate and the upper molding plate,
wherein the film supply module is configured to provide the film to a top surface of the lower molding plate when the exhaust pressure is provided to the apertures by the ventilator.

8. The substrate manufacturing facility of claim 7, further comprising:
a first valve connected to or disposed within the conduit between the vacuum pump and the upper molding plate to switch the adsorption pressure;
a second valve connected to or disposed within the conduit between the ventilator and the upper molding plate to switch the exhaust pressure; and
a controller configured to control the switching of the adsorption pressure of the first valve and the switching of the exhaust pressure of the second valve.

9. The substrate manufacturing facility of claim 8, wherein the controller is configured to close the first valve and to open the second valve when the upper molding plate is cleaned.

10. The substrate manufacturing facility of claim 8, wherein the controller is configured to close the first and second valves when the film is provided to the top surface of the lower molding plate in order to clean the upper molding plate.

11. The substrate manufacturing facility of claim 8, wherein the controller is configured to open the first valve and to close the second valve when the substrate is compressed and molded.

12. A method of manufacturing a substrate, the method comprising:
providing adsorption pressure to apertures of an upper molding plate to adsorb a substrate to the upper molding plate;
providing resin powder into grooves of a lower molding plate;
melting the resin powder in the grooves;
compressing the substrate with the melted resin powder; and
cleaning the upper molding plate by exhaust pressure.

13. The method of claim 12, wherein cleaning the upper molding plate further comprises:
providing a film to a top surface of the lower molding plate; and
providing the exhaust pressure to the apertures of the upper molding plate.

14. The method of claim 13, further comprising:
removing the film after cleaning the upper molding plate.

15. The method of claim 12, wherein:
the resin powder includes minute particles having diameters of about 5 μm or more, and
the apertures have diameters of about 3 μm or less.

16. An apparatus, comprising:
a conduit;
a vacuum pump coupled to the conduit;
a ventilator coupled to the conduit;
an upper molding plate including a first upper plate having apertures therein and a second upper plate connected to the conduit, wherein the second upper plate is connected to the first upper plate, and wherein the vacuum pump is configured to adsorb a printed circuit board to the first upper plate through adsorption pressure applied through the apertures;
a lower molding plate including grooves therein; and
a resin supply tray configured to provide resin powder into the grooves of the lower molding plate, wherein:
the lower molding plate is configured to melt the resin powder;
the upper molding plate is configured to compression-mold the printed circuit board with the melted resin powder using the lower molding plate, and
the ventilator is configured to clean residue particles of the resin powder from the upper molding plate by exhaust pressure applied through the apertures.

17. The apparatus of claim 16, further comprising:
a film disposed on the lower molding plate to protect the lower molding plate from the residue particles of the resin powder.

18. The apparatus of claim 16, wherein the conduit includes first and second valves connected thereto, and the apparatus further comprises:
a controller coupled to the first and second valves, wherein the controller is configured to open the first valve and close the second valve to cause the vacuum pump to apply the adsorption pressure, and wherein the controller is configured to close the first valve and open the second valve to cause the ventilator to apply the exhaust pressure.

19. The apparatus of claim 18, wherein the controller is configured to cause the printed circuit board to be separated from the first upper plate by removing the adsorption pressure.

20. The apparatus of claim 16, wherein the upper molding plate includes an air path disposed between the first upper plate and the second upper plate.
